(19) United States
(12) Patent Application Publication
(10) Pub. No.: US 2024/0412093 A1
(43) Pub. Date: Dec. 12, 2024

(54) CHARACTERIZATION OF QUBIT ENVIRONMENT

(71) Applicant: IQM FINLAND OY, Espoo (FI)

(72) Inventors: Miha PAPIC, Munich (DE); Inés DE VEGA, Munich (DE)

(21) Appl. No.: 18/699,086

(22) PCT Filed: Oct. 8, 2021
(86) PCT No.: PCT/FI2021/050666

§ 371 Date: Apr. 5, 2024

(51) Int. Cl. G06N 10/70; G06N 10/40

(52) U.S. Cl. CPC G06N 10/70; G06N 10/40

(57) ABSTRACT

There is provided a method for obtaining information on one or more error sources affecting dynamics of at least one qubit, the method comprising: receiving at least one characterizing measurement of at least one qubit configured to act as a sensor for the one or more error sources affecting dynamics of the at least one qubit; determining, based on the at least one characterizing measurement, at least one characterizing signal, which describes the dynamics of the at least one qubit; providing the at least one characterizing signal as an input to a neural network trained to predict information on the one or more error sources affecting the at least one characterizing signal; and receiving as an output, from the neural network, information on the one or more error sources affecting the at least one characterizing signal.

### FIELD

Various example embodiments relate to superconducting quantum bits, i.e. qubits, and characterization of qubit environment.

### BACKGROUND

Two-level systems in quantum devices have attracted interest because they are seen as a major source of noise and decoherence in superconducting quantum devices, such as superconducting quantum bits, i.e. qubits.

### SUMMARY

According to some aspects, there is provided the subject-matter of the independent claims. Some example embodiments are defined in the dependent claims. The scope of protection sought for various example embodiments is set out by the independent claims. The example embodiments and features, if any, described in this specification that do not fall under the scope of the independent claims are to be interpreted as examples useful for understanding various example embodiments.

According to a first aspect, there is provided method for obtaining information on one or more error sources affecting dynamics of at least one qubit, the method comprising: receiving at least one characterizing measurement of at least one qubit configured to act as a sensor for the one or more error sources affecting dynamics of the at least one qubit; determining, based on the at least one characterizing measurement, at least one characterizing signal, which describes the dynamics of the at least one qubit; providing the at least one characterizing signal as an input to a neural network trained to predict information on the one or more error sources affecting the at least one characterizing signal; and receiving as an output, from the neural network, information on the one or more error sources affecting the at least one characterizing signal.

According to a second aspect, there is provided an apparatus comprising means for performing: receiving at least one characterizing measurement of at least one qubit configured to act as a sensor for the one or more error sources affecting dynamics of the at least one qubit; determining, based on the at least one characterizing measurement, at least one characterizing signal, which describes the dynamics of the at least one qubit; providing the at least one characterizing signal as an input to a neural network trained to predict information on the one or more error sources affecting the at least one characterizing signal; and receiving as an output, from the neural network, information on the one or more error sources affecting the at least one characterizing signal.

According to a third aspect, there is provided a computer program configured to cause an apparatus to perform a method of the first aspect and any of the embodiments thereof, when run on a computer.

According to a further aspect, there is provided a non-transitory computer readable medium comprising program instructions that, when executed by at least one processor, cause an apparatus to at least to perform: receiving at least one characterizing measurement of at least one qubit configured to act as a sensor for the one or more error sources affecting dynamics of the at least one qubit; determining, based on the at least one characterizing measurement, at least one characterizing signal, which describes the dynamics of the at least one qubit; providing the at least one characterizing signal as an input to a neural network trained to predict information on the one or more error sources affecting the at least one characterizing signal; and receiving as an output, from the neural network, information on the one or more error sources affecting the at least one characterizing signal.

According to a further aspect, there is provided an apparatus comprising at least one processor; and at least one memory including computer program code, the at least one memory and the computer program code configured to, with the at least one processor, cause the apparatus to perform: receiving at least one characterizing measurement of at least one qubit configured to act as a sensor for the one or more error sources affecting dynamics of the at least one qubit; determining, based on the at least one characterizing measurement, at least one characterizing signal, which describes the dynamics of the at least one qubit; providing the at least one characterizing signal as an input to a neural network trained to predict information on the one or more error sources affecting the at least one characterizing signal; and receiving as an output, from the neural network, information on the one or more error sources affecting the at least one characterizing signal.

### BRIEF DESCRIPTION OF THE DRAWINGS

FIG. 1 shows, by way of example, plots of qubit spectroscopy;

FIG. 2 shows, by way of example, a flowchart of a method;

FIG. 3 shows, by way of example, a procedure of applying a neural network to reconstruct environment parameters of a qubit.

FIG. 4 shows, by way of example, how the principal component analysis method for dimensionality reduction is used;

FIG. 5 shows, by way of example, illustration of a simple feed-forward neural network;

FIG. 6 shows, by way of example, a table of parameters of neural networks;

FIG. 7 shows, by way of example, values predicted by the neural network versus actual values of the parameters;

FIG. 8 shows, by way of examples, decays of the visibility functions and accuracies of the algorithm;

FIG. 9 shows, by way of examples, decays of the visibility functions, confusion matrix, accuracy of the neural network, loss function during the training of the neural network and performance of the neural network when considering different impurity numbers than in the training set;

FIG. 10 shows, by way of example, a process of using the trained neural network for error mitigation in quantum computers;

FIG. 11 shows, by way of example, a block diagram of an apparatus;

FIG. 12 shows, by way of example, a flowchart of a method; and

FIG. 13 shows, by way of example, a flowchart of a method.

### DETAILED DESCRIPTION

Exact microscopic structure of the environments that produces 1/f noise in superconducting qubits remains largely unknown. Noise is caused by impurities, embedded in the vicinity of the qubit, which act as two-level systems (TLSs). Qubits are circuits with resonance frequencies in the microwave range, tailored from microstructured inductors, capacitors and Josephson tunnel junctions. Two long-living eigenstates are used as logical states 0 and 1 between which transitions may be driven to realize logical quantum gates. Josephson junctions may be modelled as nonlinear inductors whose values are tuned via a bias current or an applied magnetic flux.

Loss and fluctuations due to parasitic coupling to TLS present a significant source of decoherence and parameter fluctuations for superconducting qubits.

Fluctuators may be defined as TLS being in strong contact with their own environment and incoherently flip between two states on typical experimental timescales. These incoherent state transitions are due to a combination of quantum tunnelling through the barrier and decoherence due to the coupling to the environment. In low-temperature electronics, such as quantum electronics, the fluctuators can couple to their host circuit, and the resulting fluctuations may be considered as quasi-classical random variations in circuit parameters. Fluctuators may also modify the behaviours of other TLS in the ensemble through defect-defect coupling. Very fast fluctuations average out over experimental timescales, and the fluctuators typically modify the dynamics of quantum devices via contributions to the low-frequency environmental noise spectrum, which causes the loss of phase coherence in these devices.

Coherent TLSs are those where the coupling between the TLS and their environment is weak enough to remain in one of their eigenstates, or they may be placed in a coherent superposition of states, over the timescale of an experiment. Typically, coherent TLSs have energy splittings that are larger than the thermal energy of their environment, so that incoherent excitations into their excited state are suppressed and their equilibrium steady state is their ground state. Such coherent TLS may strongly couple to their host circuit or to each other. This coupling may be characterized by a coupling strength which exceeds the decoherence rates of both the TLS and its hosting device. This kind of a strong coupling results in modifications of the energy level structure and quantum dynamics of the hosting device which may be observed, for example as avoided crossings in qubit spectroscopy or coherent beating in population dynamics. Coherent TLSs in their ground state are able to absorb energy from their host quantum circuits and dissipate it into their own environment.

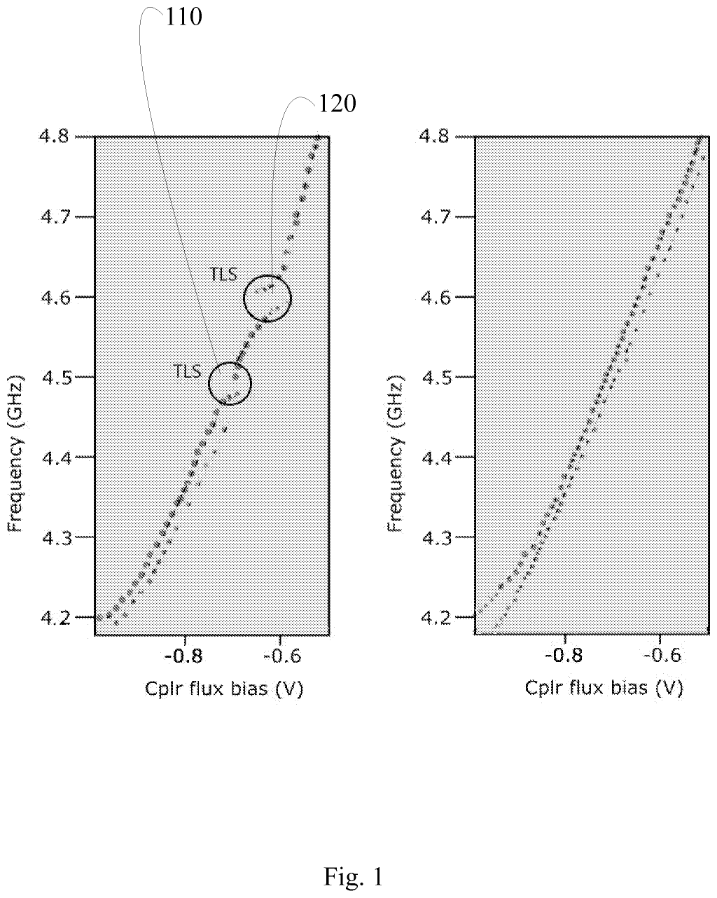

FIG. 1 shows, by way of examples, plots of qubit spectroscopy. For example, in a two-qubit gate implementation, the frequency of the coupler qubit is swiped during the gate operation. The frequency of the qubit may be varied with a magnetic flux pulse, and the qubit may be additionally driven with long microwave pulses. Then, the population of the excited state may be measured using spectroscopy. A strongly coupled impurity is clearly visible as an avoided crossing in the measured spectrum. On the left, the effect of two impurities is visible in the two observed avoided crossings 110, 120 in the spectrum. If the spectrum has an avoided crossing due to the coupling to an impurity, the fidelity of the two-qubit gate is decreased. When an avoided crossing is detected, the qubit may be cycled to room temperature in order to reset the qubit to achieve a spectrum without impurities, as shown on the right of FIG. 1.

However, typical or classical spectroscopy is very time consuming, since hundreds or even thousands of measurements would be needed to be able to detect avoided crossings as visible in the example spectrum of FIG. 1.

There is provided a method for characterizing the environment of the qubit to obtain information on one or more error sources affecting dynamics of the qubit.

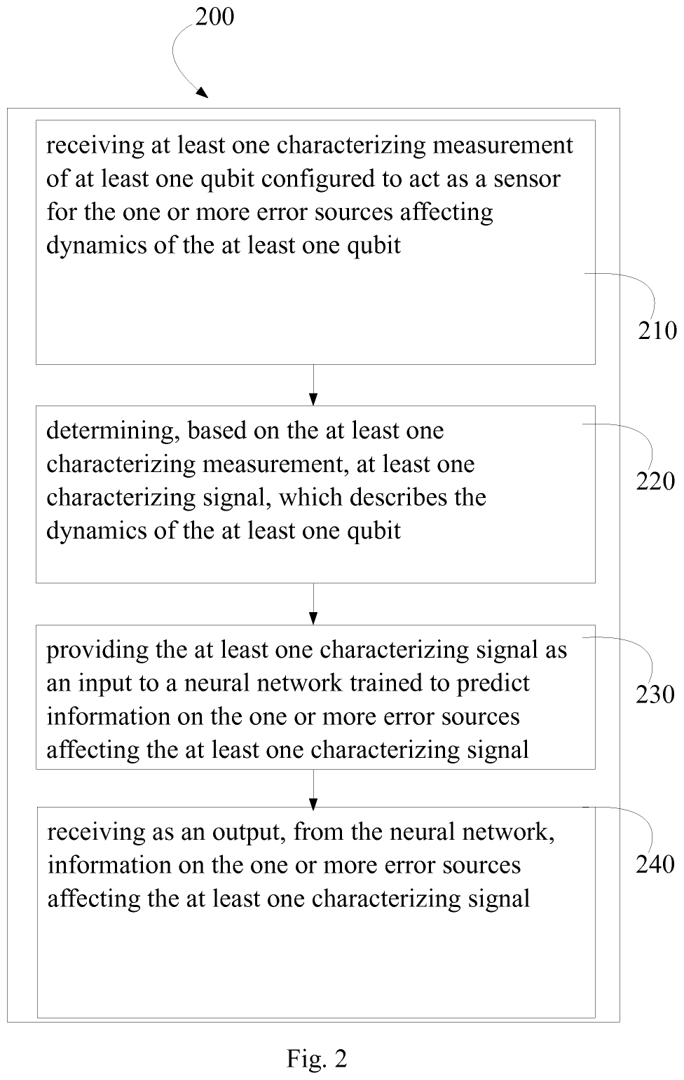

FIG. 2 shows, by way of example, a flowchart of a method for obtaining information on one or more error sources affecting dynamics of at least one qubit. The method 200 comprises receiving 210 at least one characterizing measurement of at least one qubit configured to act as a sensor for the one or more error sources affecting dynamics of the at least one qubit. The method 200 comprises determining 220, based on the at least one characterizing measurement, at least one characterizing signal, which describes the dynamics of the at least one qubit. The method 200 comprises providing 230 the at least one characterizing signal as an input to a neural network trained to predict information on the one or more error sources affecting the at least one characterizing signal. The method 200 comprises receiving 240 as an output, from the neural network, information on the one or more error sources affecting the at least one characterizing signal.

The phases of the method 200 may be performed by an apparatus such as a computer, or a group of computers. The characterizing measurement may be received from a measurement device, such as a Ramsey interferometer, or from a memory of the apparatus in which the measurement has been stored, e.g. temporally. The characterizing measurement may be a single characterizing measurement of the qubit, e.g. a coherence decay measurement.

The method as disclosed herein enables characterization of the environment of the qubit in a fast way. For example, the characterizing measurement received or obtained in the method as disclosed herein, e.g. a Ramsey type measurement, may last for approximately 30 s. whereas a typical or classical spectroscopy experiment on a qubit may last approximately 15 min or even an hour or more depending on the resolution. The method as disclosed herein enables characterization of the environment of the qubit without need to use time-consuming, classical spectroscopic techniques or tomography, for example. The method as disclosed herein enables identifying also weakly coupled impurities, which might not be visible in a classical spectroscopy measurement. The method as disclosed herein enables determination of information on the error source or noise source causing e.g. decoherence in the qubit using e.g. a single characterizing measurement of the qubit. When the error source or noise source is known, it enables taking actions to remove the error source or noise source.

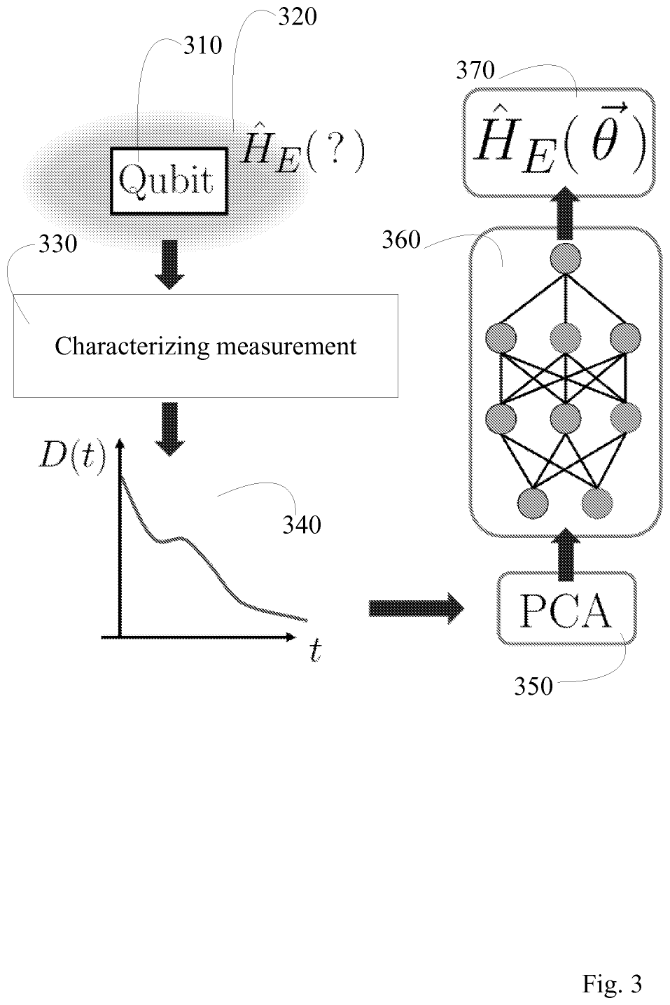

FIG. 3 shows, by way of example, a procedure of applying a neural network to reconstruct environment parameters of a qubit. A qubit 310 is subject to an environment 320 with unknown parameters or an unknown Hamiltonian. For example, a full Hamiltonian may be comprised of three parts parts

$$\\ \begin{matrix}\hat{H} = {\hat{H}}_{S} + {\hat{H}}_{I} + {\hat{H}}_{E} , & ( 1 )\end{matrix}$$

where Ĥ_{S} is the Hamiltonian of the qubit, Ĥ_{E} represents the environment and Ĥ_{I} describes the interaction between the two.

For example, a transmon is a type of superconducting charge qubit designed to have reduced sensitivity to charge noise. The qubit Hamiltonian for a commonly used transmon architecture may be expressed as

$$\\ \begin{matrix}{\hat{H}}_{S} = 4 {{E}_{C} ( \hat{n} - {n}_{g} )}^{2} - {E}_{J} cos \hat{ϕ} , & ( 2 )\end{matrix}$$

where \hat{n} is the Cooper pair number operator, n_{g}=C_{g}V_{g}/(2e₀) is the normalized gate voltage, V_{g} is the applied voltage, and C_{g} is the capacitance between the superconducting island and the gate, and \hat{ϕ} is the superconducting phase operator. Additionally, E_{C} is the charging energy and E_{J} the junction Josephson energy. These two parameters are determined by the superconducting circuit, namely the charging energy is the energy needed to add a Cooper pair to the superconducting island and is given, in terms of the junction capacitance C_{Σ}, by E_{C}=2e/C_{Σ}.

The junction may be additionally shunted by adding a loop, e.g. a direct current superconducting quantum interference device loop, that is, a de-SQUID loop, which may cause increase of the capacitance. Without this extra loop, the Josephson energy is given by E_{J}=I_{c}Φ₀/2π, where I_{c} is the critical current through the junction and do the superconducting flux quantum. Introducing the additional loop may be beneficial, because the Josephson energy is then given by E_{J}→2E_{J}|cos(πΦ/Φ₀)|, and can therefore be tuned via the application of an external magnetic flux through the loop Φ.

By considering the standard transmon design, where the circuit is fabricated so that E_{J}>>E_{C}, and truncating the Hamiltonian in Eq. (2) to the first two states, the effective qubit Hamiltonian is given by

$$\\ \begin{matrix}{\hat{H}}_{S} = \frac{1}{2} ( \sqrt{8 {E}_{C} {E}_{J}} - {E}_{C} ) {\hat{σ}}_{z} . & ( 3 )\end{matrix}$$

Environment of a qubit may be modelled e.g. using an electronic environment model (EEM) or a classical environment model.

In EEM, an electronic defect state is coupled to an electronic band which induces the dynamics in the impurity state.

$$\\ \begin{matrix}\hat{H} {}_{E}^{{}_{} EEM} = {\sum }_{i} {\hat{H}}_{i} = {\sum }_{i} {ϵ}_{i}^{{}_{} 0} \hat{b} {}_{i}^{{}_{} †} {\hat{b}}_{i} + {\sum }_{k} [ {T}_{ik} \hat{c} {}_{ik}^{{}_{} †} {\hat{b}}_{i} + h . c . ] + {\sum }_{k} {ϵ}_{ik} \hat{c} {}_{ik}^{{}_{} †} {\hat{c}}_{ik} . & ( 4 )\end{matrix}$$

Here, Ĥᵢ describes an isolated background charge: the operators \hat{b}ᵢ (\hat{b}ᵢ^{†}) annihilate (create) a fermion in the localized level ϵᵢ⁰. This fermion may tunnel, with amplitude Tᵢₖ to a band described by the operators ĉᵢₖ, ĉᵢₖ^{†} and the energies ϵᵢₖ. An important scale is the decay rate, given by the Fermi Golden Rule as Γᵢ=2πψ(ϵᵢ⁰)|Tᵢₖ|², where ψ(ϵᵢ⁰) is the density of states of the electronic band, which characterizes the relaxation regime of each background charge.

To consider such an environment Hamiltonian, it may be assumed, for example, that:
each localized level is connected to a distinct band
the band is non-degenerate (allowing only one fermion per level), which is in principle unrealistic since the states of wave vectors differing only in sign are usually degenerate. However, the presented model may still be a good approximation in 1D, by constructing (anti) symmetric combinations of the creation (annihilation) operators and assuming that only the symmetric combination interacts. This makes physical sense in terms of momentum conservation.
Impurity energies ϵᵢ⁰ are spatially uniformly distributed. Furthermore, they are considered to be deep inside their corresponding electronic bands, and that these have a large band width ΔW. This assumption is justified for impurities in superconducting qubits considering that the associated qubit energies E_{C} and E_{J} are in the 10 GHz range, and we are only interested in impurities with similar energies and timescales, which are much smaller than the width of a typical electronic band measured in eV. For this reason, also impurity experiments focus on this energy range.
The electronic bands are assumed to have a linear dispersion ϵₖᵢ=uᵢk, where uᵢ is a constant (i.e. independent of the band state index k).
The tunneling amplitudes Tₖᵢ≈Tᵢ, i.e. it does not depend on the band state k.
The distribution of the tunnelling amplitudes P_{Γ} is proportional to 1/Tᵢ.

Physically, this Hamiltonian represents one of the defect electrons which is not bound in a Cooper pair, tunnelling from a localised state to a metallic gate. The number of these unpaired electrons is currently estimated to be on the order of 10⁻⁶ to 10⁻⁸ per Cooper pair in currently available circuits.

In classical environment model, instead of describing the impurity with the number operator \hat{b}ᵢ^{†}\hat{b}ᵢ, we now use a Markovian (in the classical sense) stochastic process ξᵢ(t), which can take two discrete values, either ξᵢ(t)=0 or 1, ∀t.

Such a stochastic process may be referred to as random telegraph noise (RTN) and represents the classical version of any qubit decoherence model based on two-level systems.

The impurity may be characterized by parameters such as ϵᵢ⁰ which is the energy of the impurity, and Γᵢ which is the decay rate of the impurity, and a qubit coupling strength vᵢ. Let us consider a single fluctuator and omit the impurity index i for brevity.

When considering a state with energy ϵ⁰ at an inverse temperature β, the probability to tunnel to this state from the zero point will be exponentially suppressed as e^{-βϵ}^{⁰}.

In the classical environment model, we therefore picture the energy difference between the states ξ(t)=1 and ξ(t)=0 to be ϵ⁰. In order to recreate the effect of finite (inverse) temperature β, we introduce two switching rates γ₊ and γ₋, describing the probability for the function ξ(t) to switch from 1 to 0 (γ₊=γ_{1→0}) and vice versa. More specifically, 1/γ₊ is interpreted as the number of decays from the occupied ξ(t)=1 state per unit time. For ϵ⁰>0, γ₊>γ₋, i.e. we observe more decays from the excited state than random thermal excitations. By explicitly solving the dynamics of the stochastic process ξ(t) and applying the condition of thermal equilibrium for [symbol] ξ(t) [symbol] _{t→∞}=e^{-βϵ}^{⁰}/(1+e^{-βϵ}^{⁰}), we arrive at the intuitive relation, pointing out the detailed balance condition γ₊/γ₋=e^{βϵ}^{⁰}. Additionally, in the simulations we also assume an initial thermal equilibrium by specifying [symbol] ξ(0) [symbol] =e^{-βϵ}^{⁰}/(1+e^{-βϵ}^{⁰}).

The decay rate of an impurity and characteristic timescale in the previous quantum model is given by Γ=2πψ|T|². To observe similar dynamics in the classical picture, we define the classical version of the quantum model by matching the timescales Γ=γ₊+γ₋ so that both models will produce similar qubit coherence decays. Together with the thermal equilibrium condition from the previous paragraph this results in the mapping

$$\\ \begin{matrix}{γ}_{\pm } = \frac{Γ}{1 + {e}^{{}_{} ∓ β {ϵ}^{{}_{} 0}}} . & ( 5 )\end{matrix}$$

The aim of this relation is to consolidate the quantum and classical picture as much as possible. In order to distinguish between the dynamics produced by each model, the parameters of both models are generated so that they result in qubit coherence decays, which are as similar as possible.

One or more impurities present in the environment of the qubit, or in the vicinity of the qubit may influence the qubit Hamiltonian parameters in Eq. (2) in many ways. The impurity may produce different types of noise, for example charge noise or fluctuations in the gate voltage n_{g}, critical current I_{c} noise or fluctuations, flux noise, i.e. fluctuations in the magnetic flux threading the superconducting loop Φ.

Contributions caused by the different types of noise to the full Hamiltonian in Eq. (2) may be considered as a fluctuation of the qubit energy splitting in the truncated Hamiltonian in Eq. (3), under the assumption that the noise is adiabatic. When the timescales of the fluctuations induced in the parameters are slow enough compared to the qubit dynamics, they do not induce transitions between the qubit states. Since 1/f type noise associated with these impurities consists of a large number of fluctuators with long correlation times, due to the P_{Γ}∝1/Γ distribution, the adiabatic approximation is justified. Thus, a pure dephasing interaction Hamiltonian may be assumed

$$\\ \begin{matrix}{H}_{I} = {\hat{σ}}_{z} ⊗ {\sum }_{i} {v}_{i} \hat{b} {}_{i}^{{}_{} †} {\hat{b}}_{i} , & ( 6 )\end{matrix}$$

where vᵢ is the coupling strength, or energy shift induced by the presence of an electron in an impurity. The magnitude of this coupling depends on many parameters and type of noise (e.g. charge noise, critical current noise caused by Josephson energy fluctuations or flux noise). In the classical case the impurity number operator is replaced by the stochastic process \hat{b}ᵢ^{†}\hat{b}ᵢ→ξᵢ(t).

In general, the coupling strength vᵢ≡vᵢ^{λ}, i.e. it depends on the type of noise (λ∈{n_{g}, I_{c}, Φ}) considered. Fluctuations in parameter λ can be obtained by assuming that the fluctuations δλ of each parameter are small, and then performing a Taylor expansion of the energy difference of the two computational states.

$$\\ \begin{matrix}{v}_{i}^{{}_{} λ} = \frac{\partial {E}_{01}}{\partial λ} δ λ , & ( 7 )\end{matrix}$$

where E₀₁ is the energy difference in the first two eigenstates of the Hamiltonian in Eq. (2). The energy difference in the truncated Hamiltonian in Eq. (3) might not be sufficient, as the transmon limit E_{J}>>E_{C} was already applied and the parameter n_{g} was omitted.

In some cases, the qubit parameters can be tuned so that ∂E₀₁/∂λ=0 and in this case a second order expansion may be taken into account.

Regarding the charge noise, the charge dispersion of a transmon is equal to

$$\\ \begin{matrix}\frac{\partial {E}_{01}}{\partial {n}_{g}} \approx π {ϵ}_{1} sin ( 2 π {n}_{g} ) , & ( 8 )\end{matrix}$$

with energy

$${ϵ}_{1} = - {2}^{9} {E}_{C} \sqrt{\frac{2}{π}} {( \frac{{E}_{J}}{2 {E}_{C}} )}^{\frac{5}{4}} {e}^{- \sqrt{8 {E}_{J} / {E}_{C}}} . \qquad ( 9 )$$

A simple assumption may be made on the induced charge on the island due to the presence of an electron δn_{g}. By employing the method of image charges to satisfy the boundary condition of Maxwell's equations, the integrated surface charge on the superconductor can be approximated as δn_{g}=e_{ind}/2e=1/(2ϵ)≈0.05, where ϵ is the dielectric constant of the impurity host medium and is expected to be on the order of ϵ≈10 in aluminium oxide.

Regarding critical current noise, the current dispersion is given by

$$\\ \begin{matrix}\frac{\partial {E}_{01}}{\partial {I}_{c}} \approx \frac{{E}_{01}}{2 {I}_{c}} = \frac{\sqrt{8 {E}_{J} {E}_{C}} - {E}_{C}}{2 {I}_{c}} . & ( 10 )\end{matrix}$$

The effect of the impurity on the critical current δI_{c} may be harder to evaluate. A charged particle in the insulating layer of the Josephson junction could decrease the critical current by blocking one of the discrete conductance channels. Moreover, this means that the critical current fluctuation magnitude δI_{c} also depends on the size of the Josephson junction, since a junction with a smaller surface has less of these conduction channels. Therefore, measurements as large as δI_{c}≈0.3I_{c} have been reported in charge qubits with small junction surfaces.

Regarding flux noise, the flux dispersion of the transmon is given by

$$\\ \begin{matrix}\frac{\partial {E}_{01}}{\partial Φ} \approx \frac{2 π}{{Φ}_{0}} \sqrt{{E}_{C} {E}_{J} \vert sin ( \frac{π Φ}{{Φ}_{0}} ) tan ( \frac{πΦ}{{Φ}_{0}} ) \vert} . & ( 11 )\end{matrix}$$

In the EEM picture, the electrons spin will contribute to the external magnetic flux Φ. Assuming a spin-½ impurity, we can approximate the flux fluctuation by treating the electron as a magnetic dipole which induces a magnetic field \vec{B}_{dp} which induces a change in flux given by δΦ≈\vec{B}ₐₚ. S, where S is the surface vector of the SQUID loop.

A correlation in the reduction of spin impurities in the substrate and charge noise in the qubit has been reported, which implies a relation between sources of flux and charge noise.

In Eq. (6) describing dephasing interaction Hamiltonian it has been assumed an adiabatic noise process which results in pure dephasing. Therefore, [Ĥ_{S}, Ĥ_{I}]=0, and the diagonal elements of the qubit density matrix remain unperturbed while the off-diagonal elements of the density matrix decay. The notation of the truncated qubit Hamiltonian in Eq. (3) may be simplified by rewriting the energy splitting as Ω=\sqrt{8E_{J}E_{C}}−E_{C}, which results in H_{S}=Ω/2\hat{σ}_{z}.

In the full quantum EEM picture, the dynamics of these off-diagonal elements may be written as

$${ρ}_{01}^{S} ( t ) = {ρ}_{01}^{S} ( 0 ) {e}^{i Ω t} D ( t ) , \qquad ( 12 )$$

where the so-called visibility function or coherence decay D(t) is given by

$$D ( t ) = {e}^{i ( {\hat{H}}_{E} + \hat{Q} ) t} {e}^{- i ( {\hat{H}}_{E} - \hat{Q} ) t} , \qquad ( 13 )$$

and the operator \hat{Q} is the qubit part of the interaction Hamiltonian, which is equal to \hat{Q}=Eᵢ \hat{Q}ᵢ=Σᵢ vᵢ\hat{b}ᵢ^{†}\hat{b}ᵢ. The statistical average in the quantum example is computed by taking the trace with respect to the initial environment state, which is assumed to be thermalized.

The visibility function or coherence decay affects the measurement of any variable not confined to the diagonal density matrix elements and is therefore an experimentally accessible quantity. For example, a simple Ramsey interference measurement is a fast way to probe this quantity. Another example of an experiment that may be used to obtain the characterizing measurement, e.g. the visibility function, from the qubit is any pulse sequence of the shape pi/2+pi+pi+ . . . +pi+pi/2 with varying delays between the pulses. A single qubit rotation or single qubit gate experiment on the Bloch sphere is specified by the rotation angle (pi or pi/2) and the axis around which the rotation is performed (e.g. X or Y). The unitary operation may be written in terms of the Pauli matrices σᵢ, and a rotation angle φ, as

$${U}_{i} ( φ ) = {e}^{i \frac{φ}{2} {σ}_{i}} ,$$

where i is X, Y, Z (Pauli gates which equate, respectively, to a rotation around the x, y and z axes of the Bloch sphere). In the pulse sequence above, the pi/2 gates and pi gates may be X or Y. A further example of an experiment is a single qubit gate experiment, wherein the measurement is performed by repeating applications of the gate in question with varying time delays and then performing a typical qubit population measurement. That is, the experiment may be gate+delay+gate+delay+gate . . . +gate+measurement. Duration of the delays may be equal or it may vary.

Yet a further example of an experiment is a two-qubit gate experiment. The measurement may be performed by repeating applications of the two-qubit gate. In an example measurement, single qubit gate applications may be added in between the applications of the two-qubit gate. Thus, the experiment may be a mix of the single gate experiment and the two-qubit gate experiment.

To obtain the dynamics of the EEM the trace in Eq. (13) may be efficiently implemented by simplifying the trace over the many-body Hilbert space to a determinant in the single-body Hilbert space

$$D ( t ) = det \{ 1 - \tilde{n} + {e}^{i ( {\tilde{H}}_{E} - \tilde{Q} ) t} {e}^{- i ( {\tilde{H}}_{E} + \tilde{Q} ) t} \tilde{n} \} \qquad ( 14 )$$

and the tildes were used to accentuate the fact that the operators in the above expression are in the single-body picture. The number operator ñ is defined as ñ=ƒ_{FD}(Ĥ_{E}), where ƒ_{FD}(⋅) is the Fermi-Dirac function defined in the operator sense. In the above result, the initial state of the environment has been incorporated as a thermal one. This result is also general for all quadratic fermionic environments in the pure dephasing regime.

When simulating the dynamics of the qubit under the influence of the classical noise process, the von Neumann equation for the qubit density matrix (with ℏ=1 from here on) is given by

$$\frac{d {\hat{ρ}}_{S} ( t )}{dt} = - i [ \hat{H} ( t ) , {\hat{ρ}}_{S} ( t ) ] \qquad ( 15 )$$

where \hat{ρ}_{S} is the density matrix, and the full Hamiltonian is comprised of the system Hamiltonian and a stochastic interaction term

$$\hat{H} ( t , \vec{ξ} ) = {\hat{H}}_{S} + {\hat{H}}_{I} = \frac{Ω}{2} {\hat{σ}}_{z} + {\hat{σ}}_{z} {\sum }_{i} {v}_{i} {ξ}_{i} ( t ) . \qquad ( 16 )$$

The dependence on several stochastic processes ξᵢ has been denoted by ordering them in the vector \vec{ξ}. The differential equation can be solved easily, and as mentioned previously, only the off-diagonal elements of the density matrix are affected.

$${ρ}_{01}^{S} ( t , \vec{ξ} ) = {ρ}_{01}^{S} ( 0 ) {e}^{i Ω t} {\prod }_{i} {e}^{i {\int }_{0}^{t} dt ′ {v}_{i} {ξ}_{i} ( t ′ )} . \qquad ( 17 )$$

To obtain a quantum mean value one should perform a measurement many times and average the obtained values. In this classical approach, the final dynamics are therefore obtained by evolving the system a large number of times and then averaging the results over many realizations of the stochastic process.

This means that the off-diagonal element of the density matrix evolves as

$${ρ}_{01}^{S} ( t ) = 〈 {ρ}_{01}^{S} ( t , \vec{ξ} ) 〉 \qquad ( 18 )$$

where [symbol] . . . [symbol] represents the averaging over the stochastic process. Thus a classical visibility function or coherence decay may be defined as

$$D ( t ) = {\prod }_{i} 〈 {e}^{i {\int }_{0}^{t} dt ′ {v}_{i} {ξ}_{i} ( t ′ )} 〉 , \qquad ( 19 )$$

where it has been taken into account that each individual stochastic process is uncorrelated [symbol] ξᵢ(t)ξⱼ(s) [symbol] ∞δᵢⱼ.

Numerically this is implemented by randomly evolving each ξᵢ(t) with timesteps δt by considering the probability for the fluctuator to undergo a stochastic jump at each step as γ_{±}ⁱδt, depending on the current state. By doing this the probability to observe an even number of switches within the interval St is neglected and therefore this approach is only valid when Γᵢδt<<1.

Referring to FIG. 3, a characterizing measurement 330 is obtained from the qubit 310. The characterizing measurement may be any measurement or measurements applied to qubit or qubits, or a measurement of a qubit population. For example, a single characterizing measurement is enough for the method disclosed herein to determine information on the one or more error sources affecting a characterizing signal determined based on the characterizing measurement. For example, the characterizing measurement may be a coherence decay measurement and the characterizing signal may be e.g. the coherence decay or visibility function. For example, a Ramsey interference measurement may be used to obtain the characterizing measurement from the qubit.

A characterizing signal 340 describing qubit dynamics, e.g. a decay of the qubit D(t), may be used as input to the neural network 360 which has been trained to determine information on the one or more error sources affecting a characterizing signal determined based on a characterizing measurement. By describing qubit dynamics, it is in general meant that the signal has embedded or encoded therein information concerning the qubit dynamics, even if it is not immediately apparent what the described dynamics are. The information may be recovered using the neural network, for example.

For training purposes, the characterizing signal describing qubit dynamics may be obtained by simulation. That is, a theoretical model, which may be a numerical model, describing dynamics of the qubit may be used to generate a set of synthetic signals describing qubit dynamics, e.g. a set of synthetic coherence decays. Instead or in addition to of generating the training dataset synthetically, a large number of classical spectroscopy measurements of qubits may be used as training data. The theoretical model may in practical terms be a simulation employing randomization, such as a Monte Carlo simulation, for example.

It may be expected that if the time interval between two successive measurements is small, most of the data will be strongly correlated and will not give any new information to the neural network during the learning process. Even further, more data points warrant a larger number of neurons and a longer training process. Hence, proper data pre-processing is beneficial for the optimal training and results of a neural network.

In order to extract the relevant information from a dataset of characterizing signals, e.g. qubit coherence decays, dimensionality of the data may be used. The dimensionality reduction may be applied manually or using an algorithm, such as the principal component analysis.

For example, the principal component analysis (PCA) algorithm 350 may be used for data dimensionality reduction. PCA on a set of n vectors of dimension p, {\vec{x}ᵢ}, \vec{x}ᵢ∈R^{p}, works as follows:
1. Find the ellipsoid which best fits n data points in the full p-dimensional space.
2. Rotate your coordinate system so that it aligns with the axes of the ellipsoid. The basis vectors of the ellipsoid in this new frame are referred to as the principal components {ϕᵢ} of the dataset. They are normally ordered so that ϕ₁ is the direction of the longest axis of the ellipsoid and so on. The length of each axis of the ellipsoid is given by the variance, os, the data along principal component ϕᵢ. A longer axis therefore means more variance and more informational value.
3. Linearly transform each vector into the coordinate system defined by the p principal components.
4. Truncate each transformed vector by considering the first m<p principal components, thus reducing the dimension of the dataset from p to m. We are therefore neglecting the values of each vector \vec{x} that lie along the short axes of the ellipsoid (the ones with a small variance). The components of the new PCA transformed dataset are therefore the linear combinations of the original dataset.

In our case, an individual vector \vec{x}ᵢ is the vector of the different values of the visibility function or coherence decay at different times of a specific decay. Our dataset is therefore comprised of a number of decays measured at different time steps, so that n is the number of decays in the dataset (usually in the order of ˜10⁴), and p is the number of time steps of each visibility function (on the order of ˜₅₀₀).

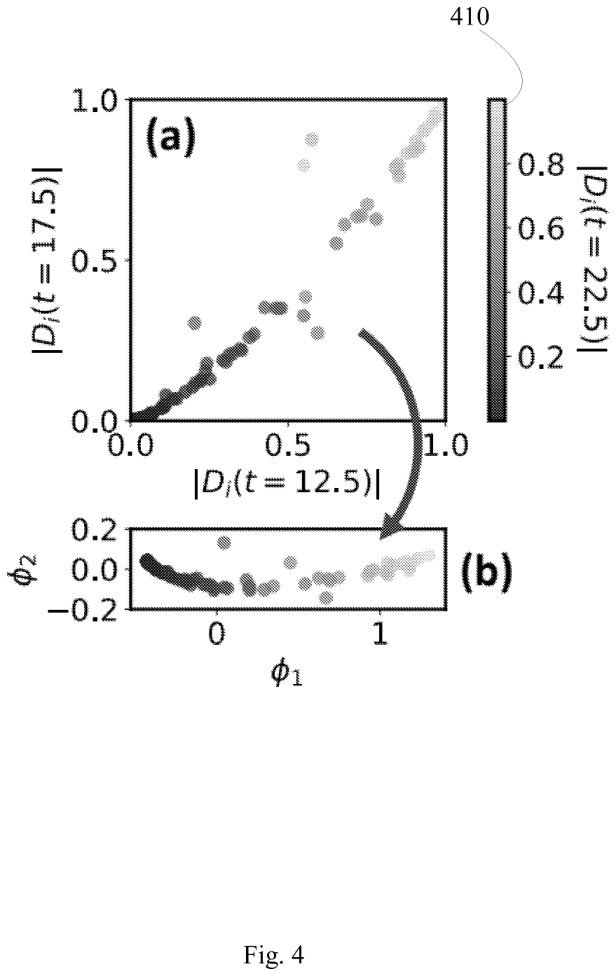

FIG. 4 (a and b) shows, by way of example, how the PCA method for dimensionality reduction is used. In the example we show how a p=3 dataset of n=100 points (100 different decays at 3 different times) shows a high degree of slightly non-linear correlation. After the PCA procedure we eliminate the 3rd PCA component and thus reduce the data to only two dimensions. The transformed data set is shown in FIG. 4b. We can see that most of the variance of the set considered here is already explained by the first PCA component ϕ₁, whereas the need for the second component arises due to the non-linearity of the correlation. A good measure for the relative importance of each PCA component ϕᵢ is the explained variance, defined as σ_{ϕ}_{ᵢ}²/Σⱼ σ_{ϕ}_{ⱼ}², which already amounts to 98.5% for the first component alone and cumulatively equals 99.8% when considering the second one.

FIG. 4a shows example dataset of {|Dᵢ(tⱼ)|} with i=1, . . . , 100 decay points calculated at three different times, tⱼ∈{12.5, 17.5, 22.5} for j=1, 2, 3 and further normalized to the interval [0, 1]. The bar 410 corresponds to |Dᵢ(t₃=22.5)| so that it is easier to distinguish approximately how each point was projected.

FIG. 4b shows how the PCA transformed data from panel (a) in terms of the first two PCA components ϕ_{1,2}.

In manual dimensionality reduction, the parameters deemed important are manually extracted and fed into the network. These parameters may relate to the decay itself, and/or may include its derivatives or its Fourier transform. In manual dimensionality reduction, the variance of parameters may be inspected and the parameters with low variance may be cancelled and the parameters with large variance may be extracted and fed into the network.

Referring back to FIG. 3, the neural network 360 may be, for example, a feed-forward neural network or a convolution neural network or a recurrent neural network applying a supervised learning algorithm. In supervised learning, a sample of inputs with known outputs is used from which the network learns to generalize.

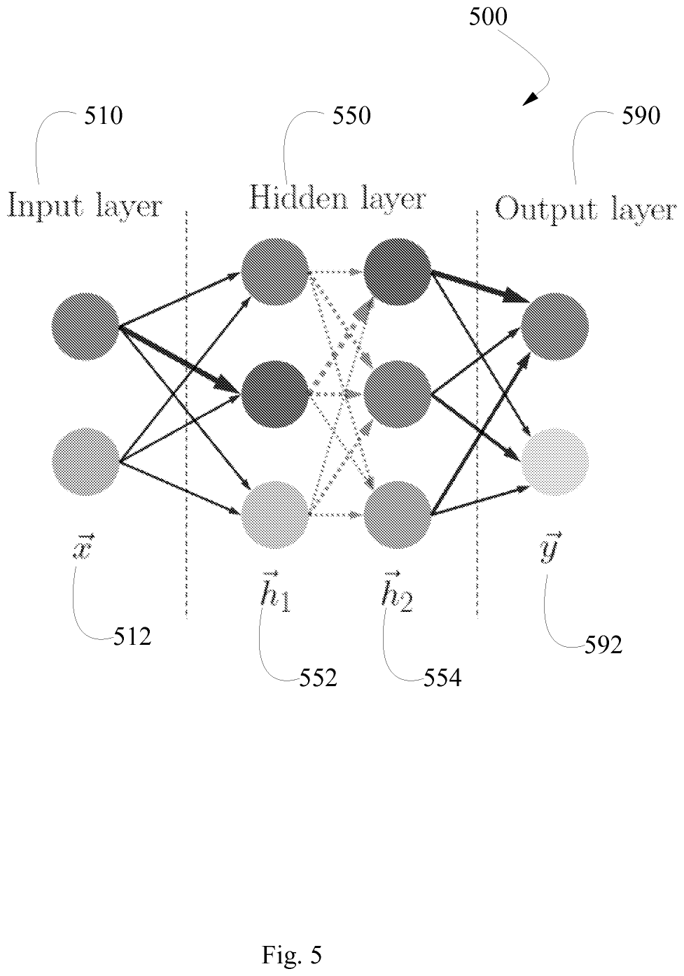

FIG. 5 shows, by way of example, illustration of a simple feed-forward neural network 500 with two inputs and two outputs together with a hidden layer 550 comprising two hidden fully-connected layers with three neurons each. The arrow size indicates the connection weight while the neuron transparency is proportional to its activation h_{1,2}ⁱ. Each circle is called a neuron and each neuron has a value associated with it, which is called the activation. The two neurons in the input layer 510 have values which we specify as our inputs. These values are then multiplied by a connection weight, indicated by the arrows, and summed together with the other connections in the next layer of the network. An additional constant referred to as a bias can also be added to the value of each neuron, denoted here as \vec{b}ᵢ which has the same dimension as the activation vector \vec{h}ᵢ. This sum of incoming signals and biases is then fed into the so-called activation function to obtain the final value, or activation, of each neuron.

Let us consider a simple neural network 500 comprising two hidden layers as illustrated in FIG. 5 In this case two numbers, indicated by the 2-component vector \vec{x} 512, are fed into the algorithm.

The values of the neurons in the next layer, indicated by the 3-component vector of activations \vec{h}₁ 552, are calculated as

$${\vec{h}}_{1} = {f}_{1} ( {V}^{i \to 1} \vec{x} + {\vec{b}}_{1} ) ,$$

where activation function ƒ₁ is scalar function ƒ₁(x):R→R and acts on each component of the vector, i.e. each neuron separately; \vec{b}₁ is an additional constant which is added to the value of each neuron and has the same dimension as \vec{h}₁. The neuron connection weights are expressed through the matrix V^{i→}∈ [symbol] ³².

The \vec{h}₁ represents transformation from the input vector \vec{x} to the first hidden layer. A linear transformation is applied to x, with the matrix V^{i→1}∈R³² and vector \vec{b}₁∈R³ (called a bias), and an element-wise non-linear transformation is then applied, defined by the activation function ƒ₁(x):R→R.

The final value in the respective neuron is therefore given by the activation function value of the vector. The role of the activation function is to introduce non-linearities into the network. The non-linearities enable the network to learn more complex relations between the input data {\hat{x}ᵢ} and output data {ŷᵢ} 592. Any function can be chosen as the activation function. Examples of the activation function are the sigmoid (ƒ(x)=1/(1+e^{-x})), ReLU (rectified linear unit, (x)=max (0, x)) and softmax function, which converts the inputs into canonical sum probabilities. This combination of biases and activation functions can be used so that a neuron is only activated if the sum of all connection values is larger than the bias, thus emulating the behaviour of a biological neuron.

The values of the neurons in the next layer, indicated by the 3-component vector of activations ĥ₂ 554, are calculated as

$${\vec{h}}_{2} = {f}_{2} ( {V}^{i \to 2} {\vec{h}}_{1} + {\vec{b}}_{2} ) ,$$

with V^{1→2}∈ [symbol] ³³ and so on until we reach the final layer. The difficult step is choosing this set of weights in the matrices V^{i→1}, V^{1→2}, V^{2→out} and biases \vec{b}₁, \vec{b}₂, \vec{b}ₒᵤₜ so that our neural network gives us the right outputs. This exemplary model contains 2·3+3·3+3·2=21 connection weights and 3+3+2=8 biases, which amounts to 29 unknown parameters. For example, the neural network applied in the method disclosed herein may comprise up to 128 neurons per layer and 64 inputs. Thus, the number of free parameters in such a network is significantly larger. Finding the optimal set of these parameters, which is referred to as learning or training, is therefore a computationally demanding task.

In order to quantify the predictive value of the network a so-called loss function is defined as a prediction accuracy measure, which is aimed to be minimized when searching for the network parameters. For example, let us consider two main classes of problems: regression problems, where a set of parameters of a given model is to be inferred, and classification problems, when the input data is to be classified into a category from a certain set.

For regression problems, the mean squared error is defined as

$${C}_{MSE} = \frac{1}{N} {\sum }_{i}^{N} {\vert {\vec{y}}_{score}^{i} - {\vec{y}}_{test}^{i} \vert}^{2}$$

where \vec{y}_{score} is the neural network vector of predicted parameters and \vec{y}ₜₑₛₜ are the actual values. In this case, the number of test samples is equal to N.

For classification tasks, a different approach is used. We represent k categories as a unitary vector with k elements where the only non-zero component represents the corresponding category. The result of the neural network may be a vector of probabilities, where each component corresponds to the network's certainty that the input is classified into each category. In other words, in addition to having as an output what is the most likely category, the output may indicate how certain the network's prediction is. In order to get a probability distribution as an output of the network the so-called softmax activation function may be used

$${f}_{out} ( \vec{z} ) = \frac{exp ( \vec{z} )}{{\sum }_{i} exp ( {z}_{i} )} ,$$

where the exponential acts on the vector element-wise in the numerator, and zᵢ are the components of \vec{z}. Since the output is interpreted as a probability distribution, the cross-entropy measure may be used as a way to estimate the distance between two probability distributions. This is defined as

$${C}_{CE} = - \frac{1}{N} {\sum }_{i}^{N} {\vec{y}}_{test}^{i} \cdot log ( {\vec{y}}_{score}^{i} ) ,$$

wherein the logarithm acts element-wise and the vector \vec{y}ₜₑₛₜⁱ has only one non-zero component. By assuring that \vec{y}_{score}ⁱ is positive and normalized (by applying the softmax function beforehand), the loss function is equal to zero (minimized) only when \vec{y}ₜₑₛₜⁱ=\vec{y}_{score}ⁱ, ∀i. The use of a softmax activation together with a cross-entropy loss is known as a categorical cross-entropy loss.

To minimize the loss function a stochastic gradient descent algorithm may be used and the gradient may be calculated via the Adaptive Moment Estimation back-propagation method. The former is a generic name for a class of algorithms based on applying the chain rule to evaluate the gradient with respect to each connection weight by iterating one layer at a time from the output backwards. The algorithm enables calculation of the gradient much more efficiently than just computing it with respect to each weight individually. Fitting these weights and network parameters is the most important step of the learning process and is often referred to as model fitting or training.

In supervised learning, a training set with known outputs ({\vec{y}ₜₑₛₜⁱ}) is used in order to minimize a loss function.

Each dataset is split into three distinct categories: Training data set, which corresponds to the vast majority (˜85%) of the inputs; validation data set (˜10%), used to test the network during the learning process, and testing data set (˜5%), used to evaluate the performance of the network after training.

While learning with the backpropagation algorithm, one complete pass through the training dataset is referred to as an epoch and the number of training samples analyzed before the model's internal parameters are updated is called a batch size.

The performance of the network may be vastly improved by normalizing the input and output data, so that the input neurons all receive a number on the order of magnitude of 1. For this purpose different scalers can be used, like for example the simple MinMax function, which simply normalizes the data into the interval [0, 1], without changing the distribution. As another example, a standard scaler may be used which outputs a normally distributed set of parameters.

Referring back to FIG. 3, the neural network 360 is trained to predict environment parameters denoted by \hat{θ} that affect the dynamics of the qubit 310. Thus, the output provided by the trained neural network 360 may be, for example, the environment parameters that affect the dynamics of the qubit. The Hamiltonian of the qubit representing the environment, Ĥ_{E}, 370 may be solved based on the output provided by the neural network 360.

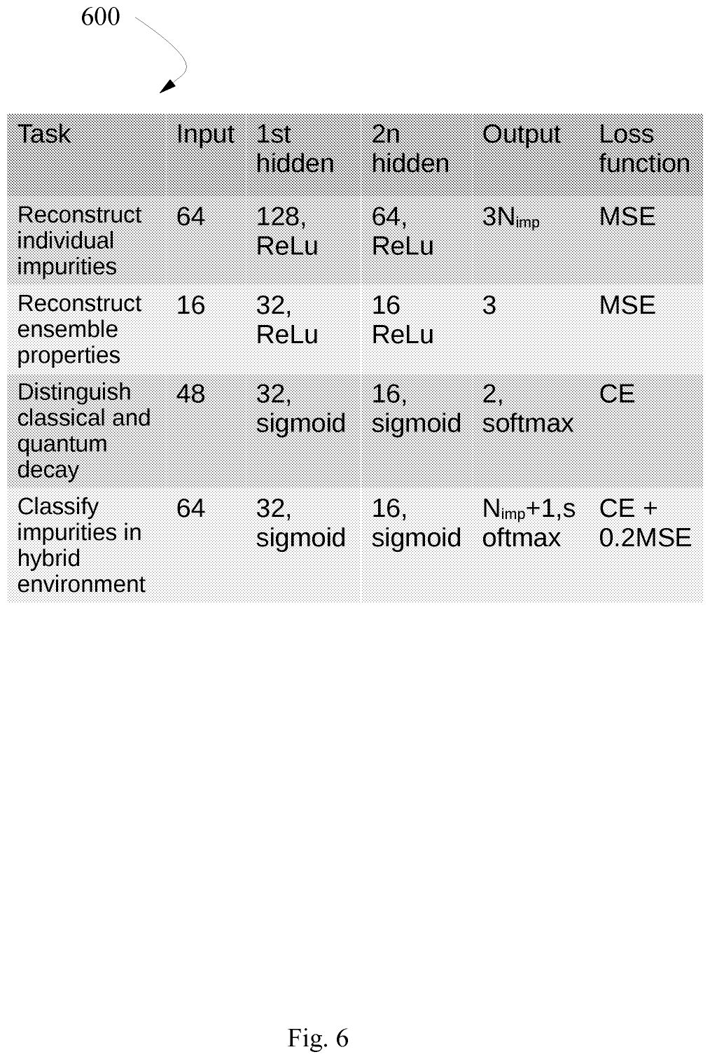

FIG. 6 shows, by way of example, a table 600 of parameters of neural networks. The present disclosure is not limited to this specific example. The columns specify the size of the layers of the neural network and the activation function used, if applicable. The mean squared error (MSE) has been used as the loss function for the tasks of reconstructing individual impurities and ensemble properties. Cross entropy (CE) has been used as the loss function for the task of distinguishing classical and quantum decay. A hybrid loss function has been used for the task of classifying impurities in a hybrid environment: C=C_{CE}+αC_{MSE}, where the value of a is, for example, α=0.2, or other suitable small value. The minimum value of this hybrid loss function is zero.

The number Nᵢₘₚ refers to the number of impurities to be characterized or reconstructed. More specifically this means that even though a large number of impurities are affecting the qubit, the ones which have the strongest effect on the qubit are the most interesting.

In all tasks of FIG. 6, approximately 10000 samples were generated and divided into training data set, validation data set, and test data set according to the proportions given above. A fixed inverse temperature may be considered and the temperature may be assumed to be known and constant. The temperature may be set at β=1 GHz, corresponding to a typical dilution refrigerator temperature of 8 mK.

A large number of synthetic signals may be generated, e.g. decay signals, with a theoretical model of the environment of the qubit. For example, the absolute value of different synthetic visibility functions |D(t)| may be used in training the algorithm. The decay curves may be reduced to a set of relevant data points with the PCA method, re-scaled into the interval [0, 1] and later used to train the algorithm. The training may last for example, 100, 200, or 100-200 epochs.

Coupling strength of each impurity affects the accuracy of the prediction. In the quantum EEM, the quotient of these two parameters vᵢ/Γᵢ may be a good measure of the effect of the impurity with the label i on the qubit decay. In this regard, more strongly coupled impurities produce a highly non-Markovian decay with coherence revivals, while weakly coupled impurities result in an exponential decay. Such non-Markovian qubit decay produced by strongly coupled impurities implies a back-flow of information from the impurities into the qubit, thus making it more simple for the algorithm to characterize their parameters than for weakly coupled ones.

Similarly, in the classical case, in the case of ϵᵢ⁰=0, there are two regimes governing the decay of the qubit under the influence of a single fluctuator. Non-Markovian dynamics with coherence revivals are observed when vᵢ/Γᵢ≥1, in direct analogy with the quantum example.

Varying the impurity energy changes the qubit behaviour. A symmetric exponential drop off may be added to the coupling measure, so that the impurity coupling strength is characterised by the parameter

$${η}_{i} = \frac{{v}_{i}}{{Γ}_{i} cosh ( {βϵ}_{i}^{0} )} ,$$

in both the quantum and classical picture, for example.

When considering a wide interval when generating the impurity energies, a large number of impurities with energies larger than 1/β have a very small coupling coefficient and therefore also have a negligible effect on the qubit. In this case, it might not be reasonable to try to extract the information of these impurities, as they do not significantly contribute to the decoherence, while forcing to deal with larger neural networks which need more resources to be trained. Thus, predictions may be limited to a relevant subset of all the impurities in the environment.

### Hamiltonian Reconstruction

For example, let us consider the quantum EEM with a fixed number of 5 impurities. The data sets were created by the considering dynamics from random Hamiltonians with energies ϵᵢ⁰ within a range of [−5, 5]β⁻¹ and tunneling amplitudes generated as Tᵢ=0.3 exp(−1.7zᵢ), where zᵢ is a uniformly distributed random variable from the interval [0, 1]. When the energy distribution is wider than β⁻¹, all impurities are not affecting the qubit, which means that the network will be able to estimate the number of relevant impurities up to some degree. Similarly, in the classical model the absolute value of the energy is relevant since it represents the energy difference between the two states.

The qubit couplings were distributed around the mean value [symbol] vᵢ [symbol] =1 with an additional normally distributed component with a magnitude of δv=0.1. The electronic band has a full bandwidth of W=40 and density of states ψ=10. These parameters were chosen so that the they emulate a continuous band as best as possible. We compute the qubit decay in the time interval [0, 25] with 500 equidistant points.

The neural network was trained to estimate the values of these parameters, i.e. the energies, tunneling amplitudes and qubit couplings from those impurities with energies close to the band edge which is fixed to ϵ=0. Due to the coupling effects mentioned previously, the normalized parameters of the EEM Hamiltonian were predicted. This is done to help with the learning process. An impurity with a large energy has a small effect on the decoherence and is more difficult to reconstruct. The normalized dimensionless versions of the Hamiltonian parameters are constructed and may be defined as

$${e}_{i} = 1 / cosh ( {βϵ}_{i}^{0} ) ,$$

$${t}_{i} = - log ( {T}_{i} {t}_{exp} ) / cosh ( {βϵ}_{i}^{0} ) ,$$

$${w}_{i} = {v}_{i} / cosh ( {βϵ}_{i}^{0} ) ,$$

for each impurity i, wherein e; is the energy of the impurity (TLS energy), tᵢ is the decay rate of the impurity (TLS decay rate) and wᵢ is impurity-qubit coupling strength (TLS-qubit coupling strength).

This ensures that the impurities with large energies and that are therefore less detrimental to the coherence time, have a proportionally smaller effect on the convergence of the algorithm. This allows focusing on the strongly coupled fluctuators. The logarithm of the tunnelling amplitude Tᵢ is taken since the decay rate of an impurity in typical experiments can exceed several orders of magnitude. The quantity tₑₓₚ is an experimental timescale and does not significantly affect the results, and may be defined as tₑₓₚ=1.

We choose to reconstruct 3 of the 5 impurities present in the environment, since the effect of the remaining 2 is negligible in the vast majority of cases. Thus, instead of the full 15 parameters we are predicting the 9 most relevant.

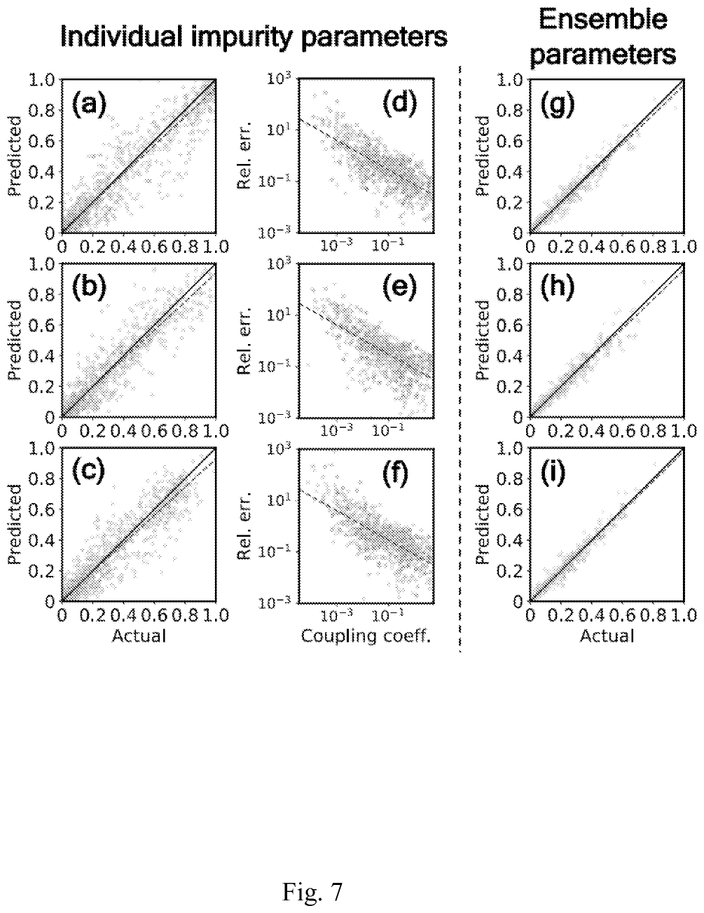

Let us analyze in FIG. 7 the prediction of the trained network for the individual impurity parameters eᵢ, tᵢ, wᵢ defined above, and as well as their sum over the ensemble. To this aim, we focus first on the individual impurity parameters in subfigures a) to f). In detail, subfigures a), b) and c), display the predicted values versus the actual ones, showing that the learning process is successful, with an approximately constant absolute prediction error of ˜0.05 for all three parameters. The fitted dashed lines in the same subfigures allow us to observe if there is an inherent bias in the predictions. In the case of all the parameters there is no apparent bias, i.e. even if the results are noisy they are on average centered around the correct values.

FIG. 7 shows, by way of examples, values predicted by the neural network versus actual values of the parameters (from top to bottom) e_{1,2,3} (a), t_{1,2,3} (b) and w_{1,2,3} (c) additionally re-scaled to the interval [0, 1], where the indices denote the first three impurities with energies closest to the band edge in a sample of 5 impurities. The black line indicates the ideal location of the values while the dashed line is a linear fit to the predictions. The subfigures d) to f) represent the relative error of the corresponding parameter plotted versus the coupling strength parameter ηᵢ. The dashed line is a linear fit to the logarithmic data. The subfigures g) to i) shows, by way of examples, the predicted versus the actual values of the re-scaled ensemble parameters Σᵢ eᵢ (g), Σᵢ tᵢ (h) and Σᵢ wᵢ (i) predicted from a separate neural network trained in a different way.

To further analyze the predictive power of strongly and weakly coupled fluctuators, subfigures d) to f) display the relative error of the data with respect to the coupling strength parameter ηᵢ. A clear downward trend is observed in the relative error of the predictions of all three parameters, showing that most of the error in our reconstruction stems from the weakly coupled impurities with less of an influence on the qubit behaviour. The relative error in the prediction in this case can be very high due to the small values of the solution combined with the learning process, which minimizes the absolute error only, irrespective of the relative error.

A smaller error is observed when focusing on the reconstruction of ensemble properties, i.e. quantities that are averaged over all the impurities in the environment as displayed in subfigures g) to i). The localization of the data around the black line shown in these subfigures suggest how the predictions are much more accurate when considering the whole ensemble. The average absolute error in this case is approximately 0.02 and this increase in accuracy is due to the fact that we are no longer trying to reconstruct the properties of a single constituent in the environment, but rather of the environment as a whole, since such global parameters are more directly linked to the observed decays.

### Hamiltonian Determination

The neural network may be used for the purpose of classification, so as to differentiate between the characterizing signals, e.g. decay signals, generated by the quantum and classical environments. This way, more knowledge may be gained about the underlying microscopic picture, rather than individual impurity properties.

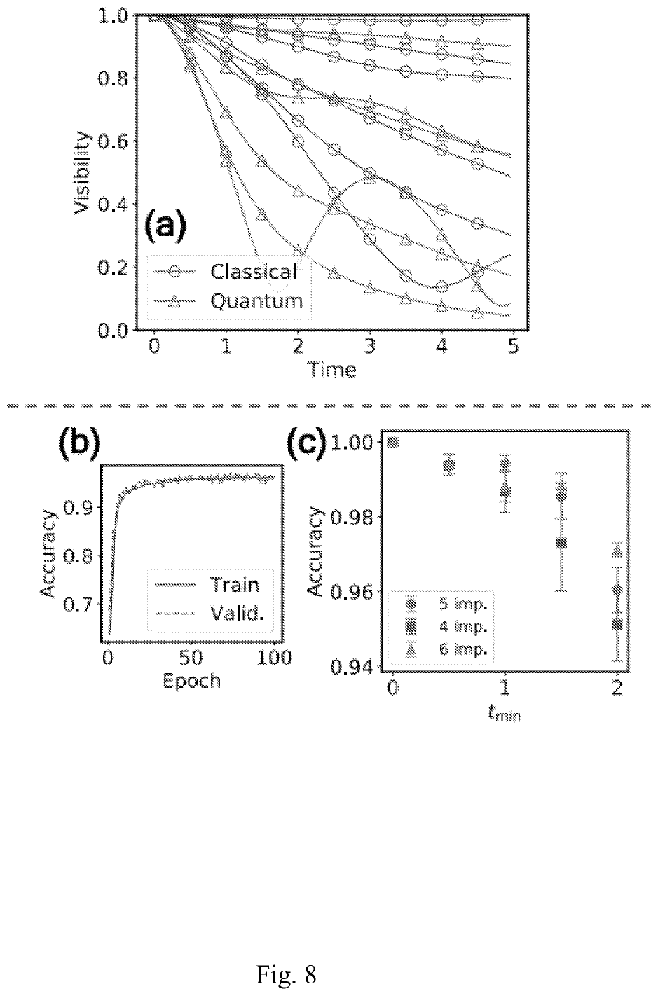

FIG. 8a shows examples of decays as absolute value of the visibility function |D(t)|. The classical and quantum decays were generated with pairwise identical parameters. In the classical case, we have averaged 500 trajectories to obtain a sufficiently smooth decay.

FIG. 8b shows the accuracy (percent of correctly classified decays) of the algorithm during the training process for the last data point in the subfigure c).

FIG. 8c shows the average accuracy of the classification algorithm. We have considered a variable time interval [tₘᵢₙ, 5] of the visibility function as the input. The network was trained on a sample with 5 impurities, but we have also tested the accuracy of the prediction on a sample environment with 4 (squares) and 6 (triangles) impurities, to demonstrate the robustness. The error bars represent the standard deviation due to different splittings of the data into test, validation and train samples (valid for the 5 impurities), as well as different network starting weights, which are generated randomly.

The data for the EEM Hamiltonian was generated identically to the data used in the context of FIG. 7, and identical parameters were used for the classical environment.

In short, different microscopic pictures imply different parameter magnitudes and characteristics. These two pictures were consolidated so that they have a similar effect on the qubit. The resulting visibility functions are plotted for some random examples in FIG. 8a. FIG. 8a shows the resulting qubit decays with the same parameters, calculated with the quantum and classical environment. Even though it may seem that the classical environment has a smaller decay rate with the same parameters, differentiating between the environments just from observing a single decay might not be easy, making the problem non-trivial.

FIG. 8c shows results of testing the network trained on a sample of 5 impurities, 4 impurities and 6 impurities. The results are not significantly affected by considering a different number of impurities, which is mostly due to the large energy distribution we have used to generate the environment. This large energy distribution means that even though there might be 5 impurities simulated, only 3 might have a noticeable effect, but there is also a large number of samples where, e.g. only 1 impurity is the dominant source of decoherence. In short, the network may be trained on a data set with a varying number of effective impurities.

### Hybrid Environment

Let us consider a hybrid environment, where some impurities are described with the quantum Hamiltonian and others by the classical stochastic process. The aim is to be able to discern how many impurities are described by each Hamiltonian.

An environment may be constructed with 8 impurities, where each impurity is randomly assigned to be either classical or quantum. Focusing again on a subset of 5 impurities, aim is to predict the number of them belonging to either classical picture or quantum picture.

The parameter distribution used to generate the decays is identical to the one used previously, with the exception of the impurity energy interval, which is now extended to the interval [−10, 10]β⁻¹, so that we have more variation in the number of effective impurities.

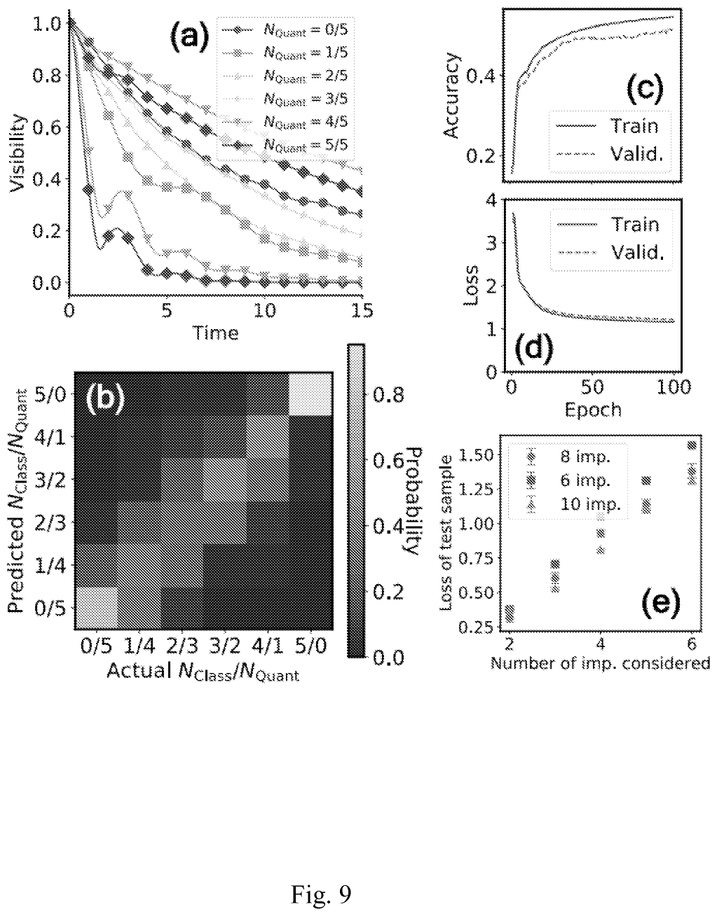

FIG. 9a shows, by way of examples, sample decays i.e. visibility functions of hybrid environments from the data set used here. The shapes and colorbar represents the number of impurities described by the quantum EEM Hamiltonian, where we have restricted ourselves to the 5 most important impurities with the smallest energy, i.e. the ones with the energies closest to the band edge (smallest energy difference between the states in the classical picture). In total 8 impurities were present in the environment used to generate the decays. The notation used here is as follows: N_{Class}/N_{Quant}=2/3 indicates that 2 impurities were classical and 3 were quantum

FIG. 9b shows, by way of example, the confusion matrix of the predictions from the data in FIG. 9a. The color values in the matrix represent the probability for a test sample with the actual number of impurities specified on the x-axis to be classified as having the number indicated on the y-axis. Therefore, the sum of the column color values must be equal to 1. However, despite not being perfect, the neural network is able to distinguish between the two models significantly better than a simple random guess, which would result in a matrix of uniform color. In other words, the confusion matrix exhibits a very diagonal structure—it is rare to see a decay with 2 quantum and 3 classical impurities being classified as one with e.g. 5 classical impurities, but it is very likely for it to be classified as having 2 classical and 3 quantum components.

FIG. 9c shows, by way of example, how the accuracy is increased during the training. FIG. 9c shows the percentage of completely accurately classified decays during the training, for the same data as in 9a and 9b.

FIG. 9d shows, by way of example, hybrid loss function during the training of the neural network. The training may be completed when the loss function of the validation sample has flattened.

FIG. 9e shows how well the network performs when considering different impurity numbers than in the training set.

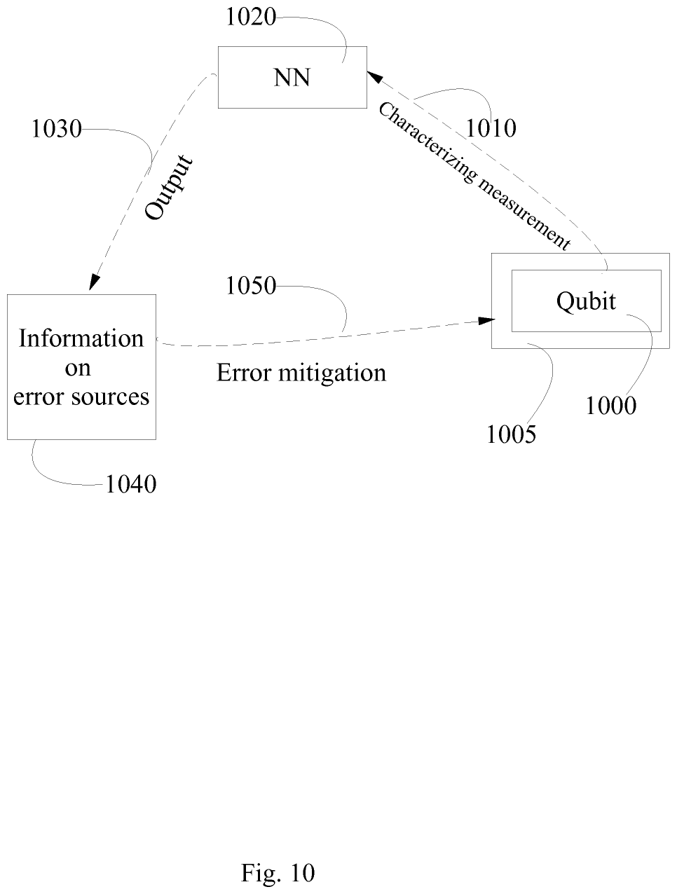

FIG. 10 shows, by way of example, a process of using the trained neural network for error mitigation in quantum computers 1005 comprising qubits 1000. At least one characterizing measurement is obtained from at least one qubit 1000. The qubit is configured to act as a sensor for one or more error sources affecting dynamics of the qubit. The measurement may be stored into a memory and retrieved from the memory for further processing. The characterizing measurement of a qubit population may be, for example, a coherence decay measurement. For example, a Ramsey interference measurement may be performed using a Ramsey interferometer. As another example, a single qubit gate experiment may be used. In the single qubit gate experiment, the measurement is performed by repeating applications of the gate in question with varying time delays and then performing a typical qubit population measurement.

Qubit 1000 may be subject to impurities in the environment of the qubit. For example, a TLS environment may comprise many TLSs which may be parametrized by coupling strength to the qubit, energy difference between qubit and impurity, and decay rate. Distribution of these parameters may be inferred by considering a simplified physical model of the impurity. The impurities may couple to the flux or charge degrees of freedom, thereby inducing decoherence and/or dephasing in the qubit. The parameters of the TLSs may be randomly distributed according to some distribution. This distribution may be estimated considering the simplified physical model of the impurity. For example, impurity may be modelled as a magnetic dipole. It is known how the magnetic field of the impurity affects the qubit parameters depending on the distance between the impurity and the qubit. From this, the distribution of the impurity-qubit couplings may be derived if it is assumed that the impurities are spatially isotropically distributed.

The characterizing measurement, or a characterizing signal determined based on the characterizing measurement, is provided 1010 as an input to a neural network 1020, which is trained to predict information on error sources affecting the characterizing signal. The neural network may receive the input from a memory, wherein the characterizing measurement or a characterizing signal has been stored. The characterizing signal describes the dynamics of the qubit 1000.

The training of the neural network 1020 may be performed, for example, as a supervised learning problem on a known training data set via stochastic gradient descent and any classical optimizer. The training is performed by minimizing a loss function, e.g. a convex loss function. Training data may be synthetic data, e.g. synthetic characterizing signals describing dynamics of a qubit. The synthetic signals may be generated by simulating a plurality of input experiments using a theoretical model describing qubit dynamics. For example, a plurality of error sources may be used in simulation such that a single gate is simulated with a specific and known error source and the infidelity is then evaluated. Infidelity is a measure of difference of two quantum states, e.g. a distance between a state obtained from a noisy evolution and a state obtained under ideal conditions. This may be performed for all error sources, and the infidelities may be summed up to obtain relative contribution of each error source. This may be done for a large number of randomly generated parameters of each error source to obtain a large dataset. The distribution of the parameters of the error sources may be determined by the underlying physical picture of the error source.

As a further example, a single gate may be simulated with a first error source and then with both the first error source and the second error source.

The synthetic signals may be divided into training and testing data sets. The training data set may be inputted to the neural network, where the parameters or weights of the neural network are updated periodically so that the difference between the outputs of the neural network and the actual parameter values of the training data set is minimized. The performance of the neural network may be evaluated using the testing data set. The parameter values here refer to the parameter values modelling the error sources.

Number of error sources or impurities affecting the qubit may be known beforehand, at least approximately. The number of impurities affecting the qubit may be estimated by performing classical spectroscopy measurement on a single sample circuit made in identical conditions as the other qubits the environment of which is characterized by the neural network as disclosed herein.

Instead of generating the training dataset synthetically, a large number of classical spectroscopy measurements of qubits may be used as training data.

The neural network 1020 may be, for example, a shallow, feed-forward type neural network, or a recurrent neural network. Activation functions used for the parameter estimation may be sigmoid activation functions. For determining the relative contribution of the different error sources, the activation function of the final layer may be softmax.

The neural network 1020 provides 1030 as the output information 1040 on the error source(s) affecting the characterizing signal. The output information may comprise, for example, relative contribution of different error sources to the characterizing signal. For example, the error sources may comprise a first error source and a second error source. The information on the error sources 1040 may comprise, for example, a first probability value indicating a probability that an effect on the characterizing signal is caused by the first error source and a second probability value indicating a probability that an effect on the characterizing signal is caused by the second error source. The error sources may all contribute to the characterizing signal, and their relative contribution may be obtained as output from the neural network. The relative contribution of different error sources is obtained by simulating a specific gate with a specific error source and by defining which kind of a contribution the error source causes to the dynamics of the qubit or gate. The probability values or relative contribution values may be given as percentages or decimals, for example. The relative contribution may be given as percentages indicating how much different error sources affect the characterizing signal. The relative contribution value of a specific error source indicate to which extent the at least one characterizing signal is affected by the specific error source.

The output information may comprise, for example, a set of parameters modelling the error source. The set of parameters may comprise, for example, TLS-qubit coupling strength, TLS-qubit energy difference, and a TLS decay rate. For example, the coupling strength may be estimated by the ratio vᵢ/Γᵢ, additionally divided by cos h(βγᵢ⁰).

Error mitigation scheme may be selected based on the information on the error sources 1040. The selected error mitigation scheme may be applied 1050 to a quantum computer 1005 comprising the qubit 1000. For example, in case the TLS-qubit coupling strength and/or TLS-qubit energy difference and/or TLS decay rate is/are above a predefined threshold, the error mitigation comprises cycling the qubit to higher temperature e.g. by heating the quantum processor.

The process as disclosed herein enables determination of error sources affecting dynamics of the qubit with less measurements than e.g. classical spectroscopic or tomographic methods to measure qubit environment. The process as disclosed herein enables efficient error mitigation to be applied to quantum computers.

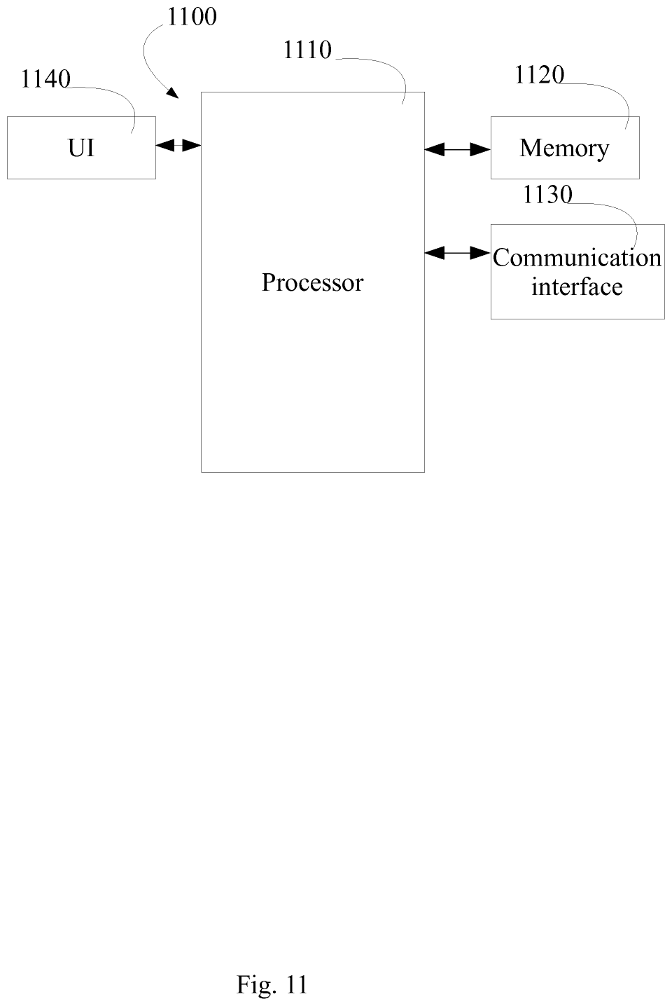

FIG. 11 shows, by way of example, an apparatus capable of performing the method as disclosed herein. The apparatus 1100 comprises one or more processors 1110. Processor 1110 may comprise or may be a control device. Processor 1110 may be means for performing method steps in the apparatus 1100, which may be a computer or a group of computers. Processor 1110 may be configured by computer instructions to perform actions.

The apparatus 1100 comprises one or more memories 1120, which may be at least in part accessible to processor 1110. Memory 1120 may be at least in part comprised in the processor 1110, or memory may be at least in part external to apparatus 1100 but accessible to apparatus 1100. Memory 1120 may be means for storing information, e.g. computer instructions that processor 1110 is configured to execute.

The apparatus 1100 comprises communication interface 1130 comprising a transmitter for transmitting information and a receiver for receiving information. For example, the apparatus may receive via the receiver measurements from a measurement device and store into a memory 1120. The apparatus may transmit via the transmitter the characterizing measurement or a signal derived from the measurement to a neural network as an input. Transmitter and receiver may be configured to transmit and receive information via wireless and wired communication technologies.

The apparatus 1100 comprises or is connected to a user interface, UI, 1160. UI 1160 may comprise at least one of a display, a keyboard, a touchscreen and a mouse. A user may be able to operate the apparatus 1100 via the UI 1160.

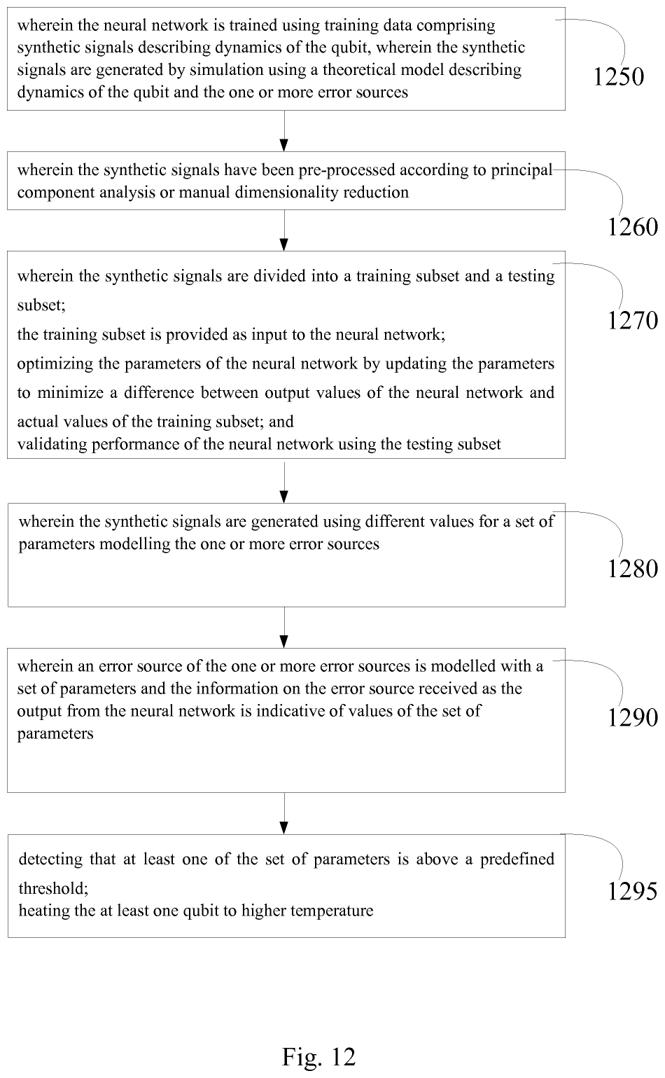

FIG. 12 shows, by way of example, a flowchart of a method. The method shown in FIG. 12 may be a continuation of the method steps shown in FIG. 2. The neural network is trained, or has been trained, 1250 using training data comprising synthetic signals describing dynamics of the qubit, wherein the synthetic signals are generated by simulation using a theoretical model describing dynamics of the qubit and the one or more error sources. The synthetic signals have been pre-processed 1260 according to principal component analysis or manual dimensionality reduction. The training process 1270 comprises: the synthetic signals are divided into a training subset and a testing subset; the training subset is provided as input to the neural network; optimizing the parameters of the neural network by updating the parameters to minimize a difference between output values of the neural network and actual values of the training subset; and validating performance of the neural network using the testing subset.

The synthetic signals are generated or have been generated 1280 using different values for a set of parameters modelling the one or more error sources.

An error source of the one or more error sources is modelled 1290 with a set of parameters and the information on the error source received as the output from the neural network is indicative of values of the set of parameters.

The set of parameters comprises: two-level system-qubit coupling strength; two-level system-qubit energy difference; and two-level system decay rate.

The method comprises detecting 1295 that at least one of the set of parameters is above a predefined threshold; and heating the at least one qubit to higher temperature.

The neural network is trained or has been trained by applying supervised learning on the known training data via stochastic gradient descent and any classical optimizer, wherein the training is performed by minimizing a loss function. The loss function may be, for example, a convex loss function.

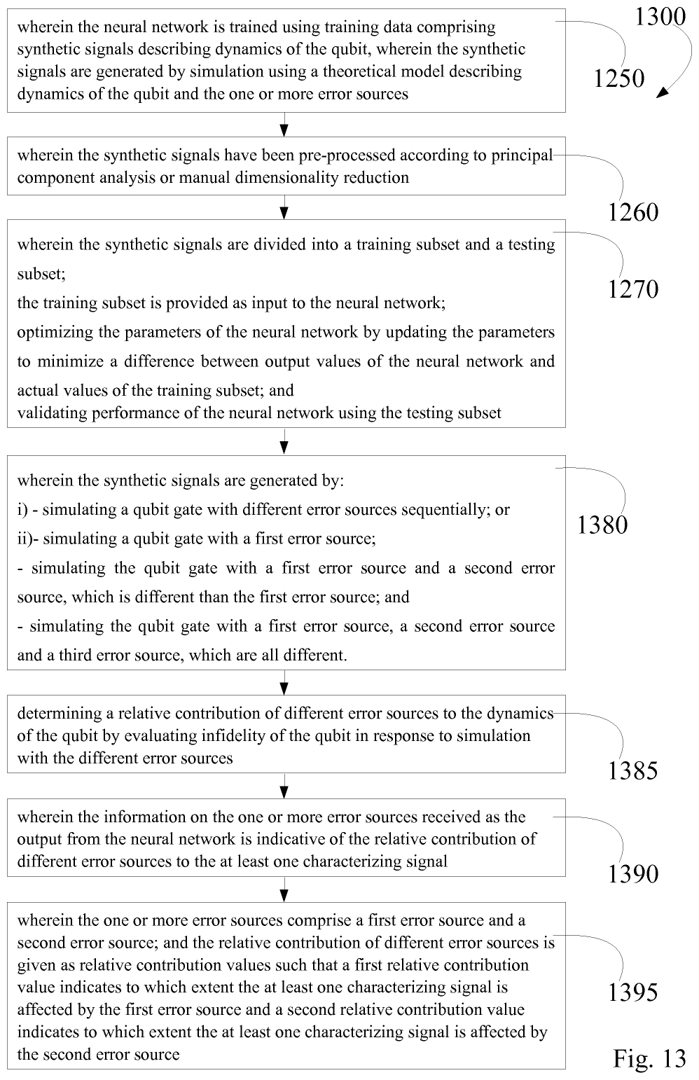

FIG. 13 shows, by way of example, a flowchart of a method. The method shown in FIG. 13 may be a continuation of the method steps shown in FIG. 2. The neural network is trained, or has been trained, 1250 using training data comprising synthetic signals describing dynamics of the qubit, wherein the synthetic signals are generated by simulation using a theoretical model describing dynamics of the qubit and the one or more error sources. The synthetic signals have been pre-processed 1260 according to principal component analysis or manual dimensionality reduction. The training process 1270 comprises: the synthetic signals are divided into a training subset and a testing subset; the training subset is provided as input to the neural network; optimizing the parameters of the neural network by updating the parameters to minimize a difference between output values of the neural network and actual values of the training subset; and validating performance of the neural network using the testing subset.

The synthetic signals are generated or have been generated 1380 by: i) simulating a qubit gate with different error sources sequentially; or ii) simulating a qubit gate with a first error source; simulating the qubit gate with a first error source and a second error source, which is different than the first error source; and simulating the qubit gate with a first error source, a second error source and a third error source, which are all different.

The method comprises determining 1385 a relative contribution of different error sources to the dynamics of the qubit by evaluating infidelity of the qubit in response to simulation with the different error sources.

The information on the one or more error sources received as the output from the neural network is 1390 indicative of the relative contribution of different error sources to the at least one characterizing signal.

The one or more error sources comprise 1395 a first error source and a second error source; and the relative contribution of different error sources is given as relative contribution values such that a first relative contribution value indicates to which extent the at least one characterizing signal is affected by the first error source and a second relative contribution value indicates to which extent the at least one characterizing signal is affected by the second error source.

1. A method for obtaining information on one or more error sources affecting dynamics of at least one qubit, the method comprising:
receiving at least one characterizing measurement of the at least one qubit configured to act as a sensor for the one or more error sources affecting the dynamics of the at least one qubit;
determining, based on the at least one characterizing measurement, at least one characterizing signal, which describes the dynamics of the at least one qubit;
providing the at least one characterizing signal as an input to a neural network trained to predict information on the one or more error sources affecting the at least one characterizing signal; and
receiving as an output, from the neural network, information on the one or more error sources affecting the at least one characterizing signal.

2. The method of claim 1, wherein the at least one characterizing measurement is at least one of:
a coherence decay measurement;
a single gate experiment comprising repeating applications of the single gate with varying time delays and performing a qubit population measurement;
a two-qubit gate experiment comprising repeating applications of the two-qubit gate with equal or varying time delays and performing a qubit population measurement;
a mix of the single gate experiment and the two-qubit gate experiment.

3. The method of claim 1, wherein the one or more error sources comprise one or more of:
Markovian decoherence;
electromagnetic field;
cosmic rays;
impurities;
flux noise;
charge noise;
critical current noise;
quasiparticles;
photon number fluctuations;
pulse over or under rotation;
pulse frequency detuning;
pulse distortion;
Landau-Zenner transitions;
leakage error.

4. The method of claim 1, comprising:
selecting an error mitigation scheme based on the output; and
applying the selected error mitigation scheme to a quantum computer.

5. The method of claim 4, wherein the error mitigation scheme comprises one or more of:
cycling the at least one qubit to higher temperature;
pulse calibration;
dynamical decoupling;
quasiparticle trapping;
post selection;
noise extrapolation;
optimal control for pulse design.

6. The method of claim 1, wherein the neural network is trained using training data comprising synthetic signals describing dynamics of the at least one qubit, wherein the synthetic signals are generated by simulation using a theoretical model describing the dynamics of the at least one qubit and the one or more error sources.

7. The method of claim 6, wherein the synthetic signals have been pre-processed according to principal component analysis or manual dimensionality reduction.

8. The method of claim 6, wherein the synthetic signals are divided into a training subset and a testing subset; and wherein the method comprises:
providing the training subset as input to the neural network;
optimizing parameters of the neural network by updating the parameters to minimize a difference between output values of the neural network and actual values of the training subset; and
validating performance of the neural network using the testing subset.

9. The method of claim 6, wherein the synthetic signals are generated using different values for a set of parameters modelling the one or more error sources.

10. The method of claim 9, wherein an error source of the one or more error sources is modelled with a set of parameters and the information on the error source received as the output from the neural network is indicative of values of the set of parameters.

11. The method of claim 9, wherein the set of parameters comprises:
two-level system-qubit coupling strength;
two-level system-qubit energy difference; and
two-level system decay rate.

12. The method of claim 10, comprising:
detecting that at least one of the set of parameters is above a predefined threshold;
heating the at least one qubit to higher temperature.

13. The method of claim 9, wherein the neural network is trained by applying supervised learning on known training data via stochastic gradient descent and any classical optimizer, wherein the training is performed by minimizing a loss function.

14. The method of claim 6, wherein the synthetic signals are generated by: i)—simulating a qubit gate with different error sources sequentially; or
ii) performing following in a sequence:
simulating a qubit gate with a first error source;
simulating the qubit gate with a first error source and a second error source, which is different than the first error source; and
simulating the qubit gate with a first error source, a second error source and a third error source, which are all different.

15. The method of claim 14, comprising:
determining a relative contribution of different error sources to the dynamics of the at least one qubit by evaluating infidelity of the at least one qubit in response to simulation with the different error sources.

16. The method of claim 15, wherein the information on the one or more error sources received as the output from the neural network is indicative of the relative contribution of different error sources to the at least one characterizing signal.

17. The method of claim 16, wherein the one or more error sources comprise a first error source and a second error source; and the relative contribution of different error sources is given as relative contribution values such that a first relative contribution value indicates to which extent the at least one characterizing signal is affected by the first error source and a second relative contribution value indicates to which extent the at least one characterizing signal is affected by the second error source.

18. An apparatus comprising at least one processor configured to performing a method for obtaining information on one or more error sources affecting dynamics of at least one qubit, the method comprising:
receiving at least one characterizing measurement of the at least one qubit configured to act as a sensor for the one or more error sources affecting the dynamics of the at least one qubit;
determining, based on the at least one characterizing measurement, at least one characterizing signal, which describes the dynamics of the at least one qubit;
providing the at least one characterizing signal as an input to a neural network trained to predict information on the one or more error sources affecting the at least one characterizing signal; and
receiving as an output, from the neural network, information on the one or more error sources affecting the at least one characterizing signal.

19. The apparatus of claim 18, wherein the apparatus comprises further comprises at least one memory including computer program code, the at least one memory and the computer program code configured to, with the at least one processor, cause the performance of the apparatus.

20. A non-transitory computer readable medium having computer-executable instructions stored thereon that, when executed by at least one processor, cause an apparatus to perform a method for obtaining information on one or more error sources affecting dynamics of at least one qubit, the method comprising:
receiving at least one characterizing measurement of the at least one qubit configured to act as a sensor for the one or more error sources affecting the dynamics of the at least one qubit;
determining, based on the at least one characterizing measurement, at least one characterizing signal, which describes the dynamics of the at least one qubit;
providing the at least one characterizing signal as an input to a neural network trained to predict information on the one or more error sources affecting the at least one characterizing signal; and
receiving as an output, from the neural network, information on the one or more error sources affecting the at least one characterizing signal.
